(19) United States
(12) Patent Application Publication
(10) Pub. No.: US 2020/0256253 A1
(43) Pub. Date: Aug. 13, 2020

(54) PEAK THERMAL PROTECTION OF A TURBOFAN ENGINE COMPONENT USING PHASE CHANGE MATERIAL

(71) Applicant: United Technologies Corporation, Farmington, CT (US)

(72) Inventors: Nigel David Sawyers-Abbott, South Glastonbury, CT (US); Federico Papa, Ellington, CT (US)

(21) Appl. No.: 16/271,213

(22) Filed: Feb. 8, 2019

(51) Int. Cl. F02C 7/24

(52) U.S. Cl. CPC F02C 7/24; F05D 2260/231

(57) ABSTRACT

A gas turbine engine system includes a gas turbine engine, a temperature-sensitive component, and a thermal protection structure. The gas turbine engine has an engine core that generates heat while operational and for a period after operation. The temperature-sensitive component is disposed at a component location proximate the engine core. The thermal protection structure is interposed between the temperature-sensitive component and the gas turbine-engine, and includes a phase change material (PCM) layer disposed to absorb a transient heat spike from the engine core.

### BACKGROUND

The present disclosure relates generally to thermal protection systems, and more specifically for a thermal protection system including a phase change material sleeve or cover to protect a turbofan engine component such as a starter air valve from transient high temperature conditions.

Aircraft gas turbine engine components such as electronics and valves often require cooling to operate under hot engine conditions. During ordinary operation, cooling for many such components is provided primarily in the form of cold airflow driven by the engine itself. Immediately after engine shut-down this cooling airflow becomes unavailable, and the resulting transient heat spike creates “soak-back” conditions with significantly increased ambient temperature in the engine core compartment as engine heat disperses into areas otherwise protected by cooling airflow. Soak-back conditions constitute the harshest (i.e. highest temperature) operating conditions for many components, and often define the reliability of these components.

### SUMMARY

In one aspect, the present disclosure is directed to a gas turbine engine system that includes a gas turbine engine, a temperature-sensitive component, and a thermal protection structure. The gas turbine engine has an engine core that generates heat while operational and for a period after operation. The temperature-sensitive component is disposed at a component location proximate the engine core. The thermal protection structure is interposed between the temperature-sensitive component and the gas turbine-engine, and includes a phase change material (PCM) layer disposed to absorb a transient heat spike from the engine core.

In another aspect, the present disclosure is directed to a thermal protection structure for a temperature-sensitive component. The temperature-sensitive component is rated for a maximum temperature T_{Max}, and disposed proximate an engine core of a gas turbine engine. The thermal protection structure includes a PCM layer and a thermally insulating layer. The PCM layer is formed of a PCM having a state transition at a temperature less than T_{Max}, and at least partially surrounds the temperature-sensitive component. The thermally insulating layer at least partially surrounds the PCM layer, and is disposed between the PCM layer and the engine core.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic view of a thermal protection structure for an aircraft gas turbine engine component.

FIG. 2 is a graph of comparative temperature as a function of time with vs. without thermal protection as provided by the structure of FIG. 1.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

The present disclosure concerns a thermal protection structure that shelters a temperature-sensitive component within a gas turbine engine from transient high temperatures. This thermal protection structure can include a protective structure such as a shell, sleeve, or jacket that at least partially surrounds the temperature-sensitive component, and includes a layer of phase change material (PCM) distributed about the protective structure. This PCM acts as a thermal capacitor, allowing the protective structure to absorb heat during transient high temperature conditions so as to protect the temperature-sensitive components.

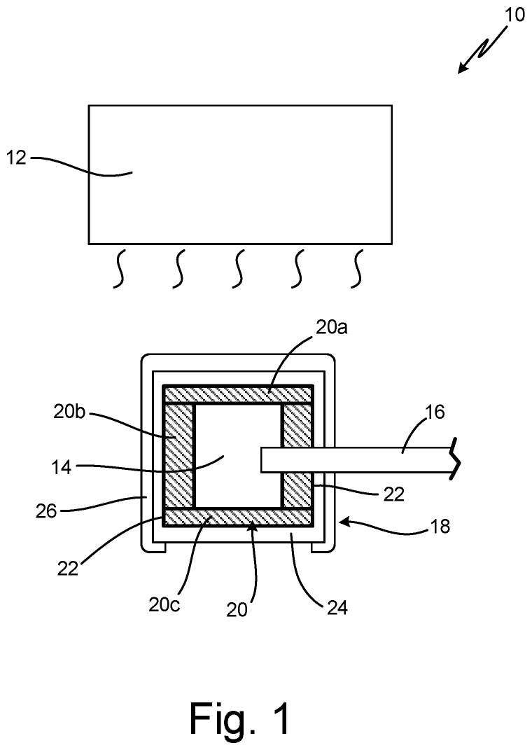

FIG. 1 provides a simplified schematic view of gas turbine engine system 10, which includes engine core 12, temperature-sensitive component 14, cooling system 16, and thermal protection structure 18. Thermal protection structure 18 is illustrated with PCM layer 20 (including PCM sections 20a, 20b, and 20c), intermediate layer 24, PCM container 22, and outer layer 26.

Gas turbine engine system 10 constitutes a Brayton cycle device such as an aircraft gas turbine engine, together with peripheral components and devices driven by, servicing, or otherwise coupled to the engine itself. Engine core 12 is a high-temperature region of gas turbine engine system 10, such as a region surrounding or near a combustor, high-pressure turbine, or other hot section structure. In the most general case, engine core 12 is a source of potentially deleterious heat that must be mitigated if temperature-sensitive component 14 is to function safely and reliably for its full expected lifetime. This heat can, e.g. during soakback conditions, be dissipated into other components of the engine through radiation, conduction, and convection.

Temperature-sensitive component 14 is an engine component or peripheral device situated near engine core 12, such that heat from engine core 12 imposes restrictions on the operation or design of temperature-sensitive component 14. More specifically, temperature-sensitive component 14 is rated for a maximum temperature T_{Max} less than a peak unmitigated temperature T_{peakU} anticipated in the vicinity of temperature-sensitive component 14, within gas turbine engine system 10. Temperature-sensitive component 14 could be exposed to temperatures as high as peak unmitigated temperature T_{peakU}, absent cooling or other thermal protection as disclosed herein. In an exemplary embodiment, temperature-sensitive component 14 can be a starter air valve operable (e.g. manually) to provide environmental air into engine 12 during engine starting. This starter air valve can, for example, be prone to leaking, damage, or other failures when exposed to temperatures above T_{Max}. In other and more general embodiments, temperature-sensitive component 14 can for example be an electronic device, mechanical component, fluid element, or other component requiring heat mitigation to function in proximity to engine core 12.

Cooling system 16 is a fluid-based cooling system that functions while the gas turbine engine is operational. Cooling system 16 can, for example, be an air system driven by gas turbine engine system 10 that delivers cooling airflow to temperature-sensitive component. In some embodiments, cooling system 16 can be a dedicated system for temperature-sensitive component 14, but many embodiments of cooling system 16 can service multiple components requiring cooling, including elements not protected by thermal protection structure 18 or situated near engine core 12. Some embodiments of cooling system 16 can be actively powered by gas turbine engine system 10, while other embodiments can cool temperature-sensitive component 14 passively with ambient air or other fluid available while the engine is running. In the primary embodiments described herein cooling system 16 ceases operation if the gas turbine engine is not running. Some embodiments of cooling system 16, however, may continue to function at full or partial capacity even while the engine is stopped.

Thermal protection structure 18 protects temperature-sensitive component 14 from transient temperature spikes corresponding to peak unmitigated temperature T_{peakU}. Although the present disclosure focuses on peak thermal events corresponding to soak-back conditions after engine operation (and consequently after cooling system 16 has deactivated), a person skilled in the art will recognize that thermal protection structure 18 can be used more generally to protect temperature-sensitive component 14 from any transient heat spike, and may be capable of completely replacing cooling system 16.

Thermal protection structure 18 can, for example, be a shell, sleeve, jacket, blanket, or other protective cover that at least partially surrounds heat-sensitive component 14, and that is interposed between engine core 12 and temperature-sensitive component 14 to insulate temperature-sensitive component 14 from engine core 12. In the embodiment illustrated in FIG. 1, thermal protection structure 18 includes PCM layer 20, PCM container 22, intermediate layer 24, and outer layer 26. Some embodiments of thermal protection structure 18 may omit PCM container 22, intermediate layer 24, and/or outer layer 26, as described hereinafter. Furthermore, PCM layer 20 can optionally be subdivided into multiple discrete PCM sections 20a, 20b, 20c, e.g. distributed about temperature-sensitive component 14. Intermediate layers 24 and/or 26 can, in some embodiments, also act as a thermal insulator in the event of more extreme conditions (such as a fire) that could exceed the capacity of the PCM to absorb heat, e.g. in the region of 2000° F. (1093° C.), where normal operation is not expected after the event.

Thermal protection structure 18 acts as both an insulator and a thermal capacitor, protecting temperature sensitive component 14 from transient heat spikes by absorbing (and in some cases reflecting) incident heat. PCM layer 20 is formed of a PCM that undergoes a phase transition at a temperature less than T_{Max}. Thermal protection structure 18 absorbs energy as it is exposed to heat during a transient heat spike, e.g. after cooling system 16 has deactivated but before engine core 12 has cooled below T_{Max}. Most of this absorbed energy is stored in the phase transition of the PCM material, permitting thermal protection structure 18 as a way to absorb transient heat spikes with little increase in temperature. Once the entirety of PCM layer 20 has undergone this phase change, however, additional heating will cause temperatures of thermal protection structure 18 to rise further. Although the description herein focuses on embodiments of wherein PCM layer 20 undergoes a single phase change within operational temperature ranges, other embodiments of PCM layer 20 may undergo multiple phase changes over relevant temperature ranges, without departing from the scope of the present invention.

The PCM material of which PCM layer 20 is formed can preferably be a solid material that undergoes a solid-solid crystalline structure transition at a temperature less than T_{Max}. In alternative embodiments, however, PCM layer 20 can be formed of a PCM that experiences a transition into a liquid or gaseous state at a temperature less than T_{Max}. In such embodiments, PCM layer 20 can be housed within PCM container 22, a sealed, thermally conductive enclosure that prevents leakage of PCM material. In some embodiments, container 22 or another element of thermal protection structure 18 can serve as a heat spreader, distributing thermal loads across PCM layer 20.

In the illustrated embodiment, thermal protection structure 18 further includes intermediate layer 24 and outer layer 26. Layers 24 and 26 need not be present in all embodiments of the present invention. Intermediate layer 24 is formed of an insulating material such as glass, fabric, insulating gel, or other insulating material, preferably of low weight and low frangibility. Outer layer 26 can be a thermally reflective material such as a foil layer. In the illustrated embodiment, intermediate layer 24 surrounds PCM layer 20, and is situated between PCM layer and engine core 12. In some alternative embodiments, intermediate layer 20 can be situated between PCM layer 20 and temperature-sensitive component 14, and some thermal protection structures 18 may include multiple intermediate layers 20, as limited by weight and cost. Reflective outer layer 26 constitutes the outermost portion of thermal protection structure 18, and is situated between engine core 12 and other elements of thermal protection structure 18. Some embodiments of outer layer 26 may fully enclose temperature-sensitive component 14 and the remainder of thermal protection structure 18, while in other embodiments only a portion of thermal protection structure 18 may include outer layer 26, e.g. covering a region of thermal protection structure facing engine core 12.

Thermal protection structure 18 as a whole can substantially surround and at least partially enclose temperature-sensitive component 14, to shield temperature-sensitive component 14 from the hot environment of engine core 12. In some embodiments thermal protection structure 18 can be a flexible jacket or blanket compliantly fittable about temperature-sensitive component 14. In other embodiments thermal protection structure 18 can be a rigid shell, case, or box surrounding temperature-sensitive component, and shaped with a rigid geometry contoured to match or mate with a shape of temperature-sensitive component 14. In such embodiments, the structural rigidity of thermal protection structure 18 can be provided by PCM layer 20 itself, by intermediate layer 24 or outer layer 26, by PCM container 22 (if the PCM is not a solid-solid transitioning material), or by any collection of these components, in combination.

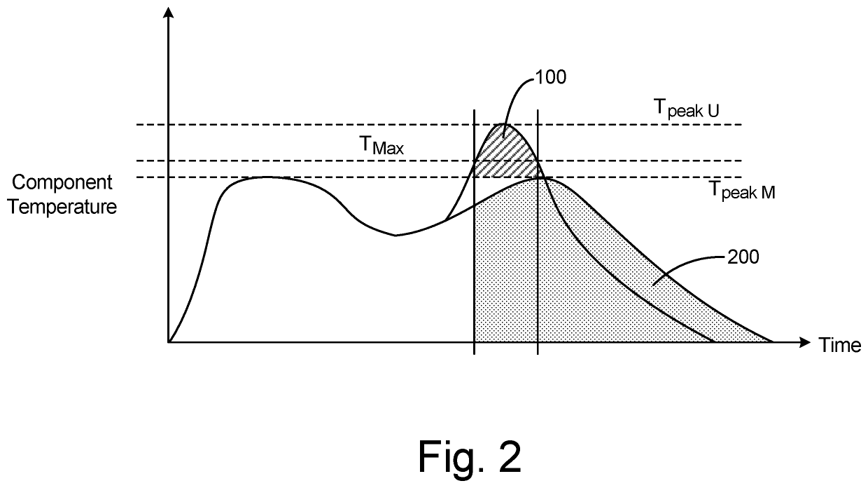

FIG. 2 is a simplified graph of temperature as a function of time over a period of operation of gas turbine engine system 10. FIG. 2 illustrates high heat period 100 and reduced experienced heat load 200. High heat period 100 and reduced experienced heat load 200 illustrate temperatures of temperature-sensitive component 14 without protection (100) and with thermal protection structure 18 (200), respectively, as a function of time over engine operation. In both cases 100, 200, temperatures generally rise with high heat loads during engine start, take-off, and climb, but stabilize during cruise (potentially falling below an initial peak at take-off) and fall during descent. During landing and reverse thrust operation component temperatures of temperature-sensitive component 14 slightly increase. Temperature curves 100, 200 diverge at engine shut-down due backsoak, as discussed above. Backsoak conditions can give rise to the highest temperatures experienced by a component, without compensation as provided by thermal protection structure 18.

High heat period 100 can, as described above, reach peak unmitigated temperatures of T_{peakU}. By contrast, reduced experienced heat load 200 never produces component temperatures at temperature-sensitive component 14 higher than peak mitigated temperature T_{peakM}<maximum rated temperature T_{Max}, as shown. PCM layer 20 of thermal protection structure 18 absorbs beat during high heat pulses 100, slowly discharging/dissipating this heat over time after high heat pulses 100 end. In this fashion, PCM layer 20 enables thermal protection structure 18 to spread the heat load experienced by temperature-sensitive component 14 over time, allowing the maximum temperature of the component to not exceed safe or non-damaging levels, despite transient heat spikes.

### DISCUSSION OF POSSIBLE EMBODIMENTS

The following are non-exclusive descriptions of possible embodiments of the present invention.

A gas turbine engine system comprising: a gas turbine engine with an engine core that generates heat while operational and for a period after operation; a temperature-sensitive component disposed at a component location proximate the engine core; and a thermal protection structure interposed between the temperature-sensitive component and the gas turbine-engine, and at least partially surrounding the temperature-sensitive component, the thermal protection structure comprising a phase change material (PCM) layer disposed to absorb a transient heat spike from the engine core.

The gas turbine engine system of the preceding paragraph can optionally include, additionally and/or alternatively, any one or more of the following features, configurations and/or additional components:

A further embodiment of the foregoing gas turbine engine system, wherein the thermal protection structure further comprises a thermally insulating layer formed disposed between the PCM layer and the engine core, and formed of fiberglass or gel.

A further embodiment of the foregoing gas turbine engine system, wherein the thermal protection structure further comprises a thermally reflective layer disposed between the thermally insulating layer and the engine core.

A further embodiment of the foregoing gas turbine engine system, wherein the thermal protection structure has a rigid geometry structurally defined by the PCM layer, the thermally insulting layer, the thermally reflective layer, or a combination of the PCM, thermally insulating, and thermally reflecting layers.

A further embodiment of the foregoing gas turbine engine system, wherein the rigid geometry at least partially encloses the temperature-sensitive component.

A further embodiment of the foregoing gas turbine engine system, wherein the rigid geometry is contoured to match a shape of the temperature-sensitive component.

A further embodiment of the foregoing gas turbine engine system, wherein the temperature-sensitive component is a flexible jacket or blanket compliantly fittable about the temperature-sensitive component.

A further embodiment of the foregoing gas turbine engine system, wherein the temperature-sensitive component is rated for a maximum temperature T_{Max} less than a peak unmitigated temperature T_{peakU} at the component location, such that exposure of the temperature sensitive component to temperatures in excess of T_{Max}, including T_{peakU}, can negatively impact the performance or expected lifetime of the temperature-sensitive component.

A further embodiment of the foregoing gas turbine engine system, wherein the PCM layer comprises a PCM material that undergoes a solid-solid crystalline structure transition at a temperature less than T_{Max}.

A further embodiment of the foregoing gas turbine engine system, wherein the PCM material is enclosed within a sealed, thermally conductive container such that the PCM material cannot escape the sealed container when in liquid form

A further embodiment of the foregoing gas turbine engine system, wherein the thermal protection structure comprises a heat spreader element disposed adjacent the PCM layer, the heat spreader unit having increased thermal conductivity relative to the remainder of the thermal protection structure.

A further embodiment of the foregoing gas turbine engine system, wherein the PCM layer comprises a plurality of separate sections of PCM material.

A further embodiment of the foregoing gas turbine engine system, further comprising a fluid cooling system coupled to the temperature-sensitive component, and configured to reduce a temperature of the temperature-sensitive component.

A further embodiment of the foregoing gas turbine engine system, wherein the fluid cooling system is a cooling air system that supplies cooling air to the temperature-sensitive component and thereby reduces a temperature of the temperature-sensitive component only during operation of the gas turbine engine, such that the transient heat spikes constitutes a period wherein the engine core generates heat after operation, when the cooling system is inactive.

A thermal protection structure for a temperature-sensitive component rated for a maximum temperature TMax and disposed proximate an engine core of a gas turbine engine, the thermal protection structure comprising: a phase change material (PCM) layer formed of a PCM having a state transition at a temperature less than TMax, and at least partially surrounding the temperature-sensitive component; and a thermally insulating layer at least partially surrounding the PCM layer, and disposed between the PCM layer and the engine core.

The thermal protection structure of the preceding paragraph can optionally include, additionally and/or alternatively, any one or more of the following features, configurations and/or additional components:

A further embodiment of the foregoing thermal protection structure, further comprising a thermally reflective layer disposed between the thermally insulating layer and the engine core.

A further embodiment of the foregoing thermal protection structure, wherein the state transition of the PCM is a solid-solid crystalline structure transition.

Summation

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A gas turbine engine system comprising:
a gas turbine engine with an engine core that generates heat while operational and for a period after operation;
a temperature-sensitive component disposed at a component location proximate the engine core; and
a thermal protection structure interposed between the temperature-sensitive component and the gas turbine-engine, and at least partially surrounding the temperature-sensitive component, the thermal protection structure comprising a phase change material (PCM) layer disposed to absorb a transient heat spike from the engine core.

2. The gas turbine engine system of claim 1, wherein the thermal protection structure further comprises a thermally insulating layer formed disposed between the PCM layer and the engine core, and formed of fiberglass or gel.

3. The gas turbine engine system of claim 2, wherein the thermal protection structure further comprises a thermally reflective layer disposed between the thermally insulating layer and the engine core.

4. The gas turbine engine system of claim 3, wherein the thermal protection structure has a rigid geometry structurally defined by the PCM layer, the thermally insulting layer, the thermally reflective layer, or a combination of the PCM, thermally insulating, and thermally reflecting layers.

5. The gas turbine engine system of claim 4, wherein the rigid geometry at least partially encloses the temperature-sensitive component.

6. The gas turbine engine system of claim 4, wherein the rigid geometry is contoured to match a shape of the temperature-sensitive component.

7. The gas turbine engine system of claim 1, wherein the temperature-sensitive component is a flexible jacket or blanket compliantly fittable about the temperature-sensitive component.

8. The gas turbine engine system of claim 1, wherein the temperature-sensitive component is rated for a maximum temperature T_{Max} less than a peak unmitigated temperature T_{peakU} at the component location, such that exposure of the temperature sensitive component to temperatures in excess of T_{Max}, including T_{peakU}, can negatively impact the performance or expected lifetime of the temperature-sensitive component.

9. The gas turbine engine system of claim 8, wherein the PCM layer comprises a PCM material that undergoes a solid-solid crystalline structure transition at a temperature less than T_{Max}.

10. The gas turbine engine system of claim 9, wherein the PCM layer comprises a PCM material that undergoes a phase transition into a liquid form at a temperature less than T_{Max}.

11. The gas turbine engine system of claim 10, wherein the PCM material is enclosed within a sealed, thermally conductive container such that the PCM material cannot escape the sealed container when in liquid form

12. The gas turbine engine system of claim 1, wherein the thermal protection structure comprises a heat spreader element disposed adjacent the PCM layer, the heat spreader unit having increased thermal conductivity relative to the remainder of the thermal protection structure.

13. The gas turbine engine system of claim 1, wherein the PCM layer comprises a plurality of separate sections of PCM material.

14. The gas turbine engine system of claim 1, further comprising a fluid cooling system coupled to the temperature-sensitive component, and configured to reduce a temperature of the temperature-sensitive component.

15. The gas turbine engine system of claim 14, wherein the fluid cooling system is a cooling air system that supplies cooling air to the temperature-sensitive component and thereby reduces a temperature of the temperature-sensitive component only during operation of the gas turbine engine, such that the transient heat spikes constitutes a period wherein the engine core generates heat after operation, when the cooling system is inactive.

16. A thermal protection structure for a temperature-sensitive component rated for a maximum temperature T_{Max} and disposed proximate an engine core of a gas turbine engine, the thermal protection structure comprising:
a phase change material (PCM) layer formed of a PCM having a state transition at a temperature less than T_{Max}, and at least partially surrounding the temperature-sensitive component; and
a thermally insulating layer at least partially surrounding the PCM layer, and disposed between the PCM layer and the engine core.

17. The thermal protection structure of claim 16, further comprising a thermally reflective layer disposed between the thermally insulating layer and the engine core.

18. The thermal protection structure of 17, wherein the thermally reflective layer is a fire protection structure.

19. The thermal protection structure of claim 16, wherein the state transition of the PCM is a solid-solid crystalline structure transition.
